(19) United States
(12) Patent Application Publication
(10) Pub. No.: US 2025/0337036 A1
(43) Pub. Date: Oct. 30, 2025

(54) BATTERY PACK CORNER COOLING AND HEATING

(71) Applicant: GM GLOBAL TECHNOLOGY OPERATIONS LLC, Detroit, MI (US)

(72) Inventors: Zhenwen HU, Shanghai (CN); Chengwu DUAN, Shanghai (CN); Jian YAO, Shanghai (CN); James B. BORGERSON, Clarkston, MI (US); Derek Frei LAHR, Ann Arbor, MI (US); Hui-ping WANG, Troy, MI (US)

(21) Appl. No.: 18/663,672

(22) Filed: May 14, 2024

(30) Foreign Application Priority Data
Apr. 29, 2024 (CN) 2024105286668

(51) Int. Cl. H01M 10/613; B60L 53/30; B67D 7/02; H01M 10/625; H01M 10/647; H01M 10/6554; H01M 10/6557; H01M 10/6563; H01M 10/6568; H01M 10/6569; H01M 10/658; H01M 10/663; H01M 50/209; H01M 50/249

(52) U.S. Cl. CPC H01M 10/613; B60L 53/30; B67D 7/0288; H01M 10/625; H01M 10/647; H01M 10/6554; H01M 10/6557; H01M 10/6563; H01M 10/6568; H01M 10/6569; H01M 10/658; H01M 10/663; H01M 50/209; H01M 50/249; H01M 2220/20

(57) ABSTRACT

A battery pack includes: prismatic battery cells arranged in two linear rows; a cooling plate disposed vertically below the battery cells; a thermal interface material disposed between the battery cells and the cooling plate; a thermal insulation material disposed at vertical bottoms of a linear space between the two linear rows of battery cells; a first cooling fluid channel that is configured to receive a cooling fluid, that extends linearly in the direction of the linear space, and that is disposed vertically above the thermal insulation material; and a second cooling fluid channel that is configured to receive the cooling fluid, that extends linearly in the direction of the linear space and parallel to the first cooling fluid channel, and that is disposed vertically above the thermal insulation material.

### CROSS-REFERENCE TO RELATED APPLICATIONS

This application claims the benefit of Chinese Patent Application No. 202410528666.8 filed on Apr. 29, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to energy storage devices and more particularly to systems and methods for heating and cooling battery packs, modules, and cells for vehicles.

Some types of vehicles include only an internal combustion engine that generates propulsion torque. Electric vehicles may not include an internal combustion engine and may rely on one or more electric motors for propulsion.

Hybrid vehicles include both an internal combustion engine and one or more electric motors. Some types of hybrid vehicles utilize the electric motor and the internal combustion engine in an effort to achieve greater fuel efficiency than if only the internal combustion engine was used. Some types of hybrid vehicles utilize the electric motor and the internal combustion engine to achieve greater torque output than the internal combustion could achieve by itself.

Some example types of hybrid vehicles include parallel hybrid vehicles, series hybrid vehicles, and other types of hybrid vehicles. In a parallel hybrid vehicle, the electric motor works in parallel with the engine to combine power and range advantages of the engine with efficiency and regenerative braking advantages of electric motors. In a series hybrid vehicle, the engine drives a generator to produce electricity for the electric motor, and the electric motor drives a transmission. This allows the electric motor to assume some of the power responsibilities of the engine, which may permit the use of a smaller and possibly more efficient engine.

### SUMMARY

In a feature, a battery pack includes: prismatic battery cells arranged in two linear rows; a cooling plate disposed vertically below the battery cells; a thermal interface material disposed between the battery cells and the cooling plate; a thermal insulation material disposed at vertical bottoms of a linear space between the two linear rows of battery cells; a first cooling fluid channel that is configured to receive a cooling fluid, that extends linearly in the direction of the linear space, and that is disposed vertically above the thermal insulation material; and a second cooling fluid channel that is configured to receive the cooling fluid, that extends linearly in the direction of the linear space and parallel to the first cooling fluid channel, and that is disposed vertically above the thermal insulation material.

In further features, the first and second cooling fluid channels have a triangular cross-section.

In further features, the first and second cooling fluid channels have a cross-sectional shape of a triangular frustum.

In further features, a second thermal insulation material extends linearly in the direction of the linear space, is disposed vertically above the thermal insulation material, and is disposed between the first and second cooling fluid channels.

In further features, the second thermal insulation material includes mica.

In further features, the second thermal insulation material has a triangular cross-section.

In further features, the second thermal insulation material has a cross-sectional shape of a triangular frustum.

In further features, the thermal insulation material includes aerogel.

In further features: second thermal interface material is disposed directly between (a) the first cooling fluid channel and (b) first faces of the battery cells of a first one of the two linear rows; and third thermal interface material is disposed directly between (a) the second cooling fluid channel and (b) second faces of the battery cells of a second one of the two linear rows.

In further features, the battery cells are rectangular prismatic battery cells.

In further features, the cooling fluid is air.

In further features, the cooling fluid includes one of water and a refrigerant.

In further features, a vehicle includes the battery pack.

In a feature, a cooling system includes: the battery pack; and a heating, ventilation, and air conditioning (HVAC) system configured to cool air and input the cool air to the first and second cooling fluid channels.

In further features, a chiller is configured to input a coolant to the cooling plate.

In a feature, a cooling system includes: the battery pack; and a heating, ventilation, and air conditioning (HVAC) system configured to input cool refrigerant to the first and second cooling fluid channels.

In further feature, a chiller is configured to input a coolant to the cooling plate.

In a feature, a cooling system includes: the battery pack; and a charging station configured to: charge the battery pack; and input the cooling fluid to the first and second cooling fluid channels.

In further features, the charging station includes: an inlet connector configured to fluidly connect to an input port to the first and second cooling fluid channels; and an outlet connector configured to fluidly connect to an output port from the first and second cooling fluid channels.

In a feature, a battery pack includes: prismatic battery cells arranged in linear rows; a cooling plate disposed vertically below the battery cells; a thermal interface material disposed between the battery cells and the cooling plate; between each pair of the rows: a first thermal insulation material disposed at vertical bottoms of a linear space between that pair of rows of battery cells; a first cooling fluid channel that is configured to receive a cooling fluid, that extends linearly in the direction of the linear space, and that is disposed vertically above the first thermal insulation material; a second cooling fluid channel that is configured to receive the cooling fluid, that extends linearly in the direction of the linear space and parallel to the first cooling fluid channel, and that is disposed vertically above the first thermal insulation material; and a second thermal insulation material that extends linearly in the direction of the linear space, that is disposed vertically above the first thermal insulation material, and that is disposed between the first and second cooling fluid channels.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIG. 2 is a perspective view of example battery cells of a battery pack;

FIG. 3 includes a perspective view including the rows of battery cells of FIG. 2 with insulation material and cooling channels disposed between the rows of battery cells;

FIG. 4 includes a cross sectional view of the example of FIG. 3;

FIG. 5 is a functional block diagram of an example heating and cooling system for the battery pack;

FIG. 6 is a functional block diagram of an example heating and cooling system for the battery pack; and

FIG. 7 is a functional block diagram and perspective view of an example cooling system involving a charging station.

In the drawings, reference numbers may be reused to identify similar and/or identical elements.

### DETAILED DESCRIPTION

A vehicle includes a battery pack that includes two or more battery modules. Each battery module includes a plurality of battery cells, such as prismatic battery cells. During charging and discharging of the battery pack, the temperature of the battery cells may rise.

The present application involves heating and cooling systems and methods for battery cells. Cooling channels may be disposed between upper corners of adjacent battery cells to increase cooling, such as during fast charging. Air or a coolant may be flowed through the cooling channels to cool the battery cells. This reduces cell temperature grading and decreases maximum cell temperature, such as during fast charging. The cooling channels also provide mechanical strength for load bearing without leakage concerns, which may improve package efficiency and reduce cost. The coolant may be provided by, for example, a charging station or a heating ventilation and air conditioning (HVAC) system of a vehicle.

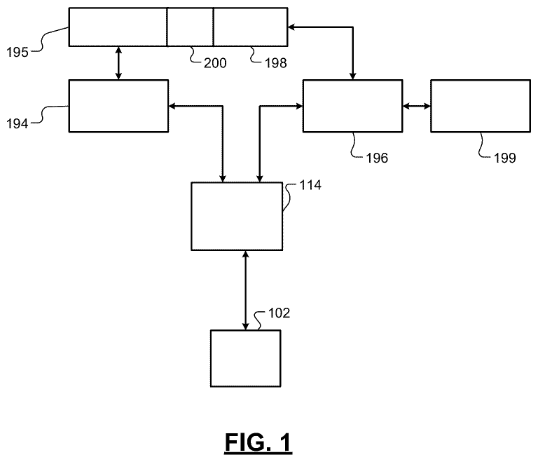

Referring now to FIG. 1, a functional block diagram of an example vehicle system is presented. While a vehicle system for a hybrid vehicle is shown and will be described, the present disclosure is also applicable to electric vehicles that do not include an internal combustion engine (including pure electric vehicles), fuel cell vehicles, autonomous vehicles, semi-autonomous vehicles, non-autonomous vehicles, and other types of vehicles. Also, while the example of a vehicle is provided, the present application is also applicable to non-vehicle implementations.

An engine 102 may combust an air/fuel mixture to generate drive torque. An engine control module (ECM) 114 controls the engine 102. For example, the ECM 114 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators. In some types of vehicles (e.g., electric vehicles), the engine 102 may be omitted.

The engine 102 may output torque to a transmission 195. A transmission control module (TCM) 194 controls operation of the transmission 195. For example, the TCM 194 may control gear selection within the transmission 195 and one or more torque transfer devices (e.g., a torque converter, one or more clutches, etc.).

The vehicle system includes one or more electric motors, such as electric motor 198. An electric motor (also referred to as an electric machine) can act as either a generator or as a motor at a given time. When acting as a generator, an electric motor converts mechanical energy into electrical energy. The electrical energy can be, for example, used to charge a battery pack 199. When acting as a motor, an electric motor generates torque that may be used, for example, for vehicle propulsion. While the example of one electric motor is provided, the vehicle may include more than one electric motor.

A motor control module 196 controls power flow from the battery pack 199 to the electric motor 198 and from the electric motor 198 to the battery pack 199. The motor control module 196 applies electrical power from the battery pack 199 to the electric motor 198 to cause the electric motor 198 to output positive torque, such as for vehicle propulsion. As discussed further below, the battery pack 199 includes one or more battery modules, and each battery module includes a plurality of battery cells.

The electric motor 198 may output torque, for example, to an input shaft of the transmission 195 or to an output shaft of the transmission 195. A clutch 200 may be engaged to couple the electric motor 198 to the transmission 195 and disengaged to decouple the electric motor 198 from the transmission 195. One or more gearing devices may be implemented between an output of the clutch 200 and an input of the transmission 195 to provide a predetermined ratio between rotation of the electric motor 198 and rotation of the input of the transmission 195.

The motor control module 196 may also selectively convert mechanical energy of the vehicle into electrical energy. More specifically, the electric motor 198 generates and outputs power via back EMF when the electric motor 198 is being driven by the transmission 195 and the motor control module 196 is not applying power to the electric motor 198 from the battery pack 199. The motor control module 196 may charge the battery pack 199 via the power output by the electric motor 198.

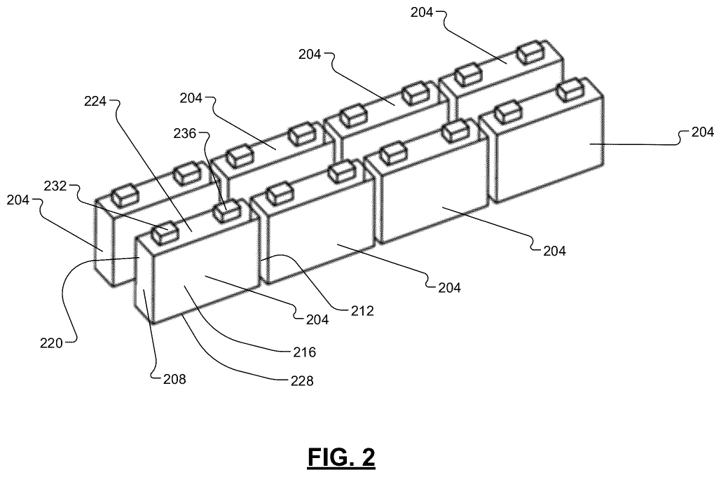

FIG. 2 is a perspective view of example battery cells of the battery pack 199. The battery pack 199 may include 2 or more battery modules where each battery module includes two or more battery cells. Eight battery cells 204 are illustrated in FIG. 2.

Example battery cells are illustrated by 204. The battery cells 204 may be rectangular prismatic battery cells or another suitable type of battery cell. In various implementations, the battery pack 199 may include multiple different sizes and/or shapes of battery cells.

The battery cells 204 include opposing left and right side faces 208 and 212, opposing front and rear side faces 216 and 220, and opposing top and bottom faces 224 and 228. Each battery cell 204 includes a positive terminal and a negative terminal, such as 232 and 236. The positive and negative terminals 232 and 236 may both be disposed on the same face of that battery cell. In the example of FIG. 2, the positive and negative terminals 232 and 236 are disposed on the top face 224. The positive and negative terminals of the battery cells are electrically connected in series, parallel, or a combination of series and parallel.

The battery pack 199 includes at least two rows of battery cells. In the example of FIG. 2, the right side face 212 of one battery cell is arranged facing the left side face 216 of another battery cell. This continues to form a row. Two rows of battery cells are illustrated in FIG. 2. In the example of FIG. 2, the rear side faces 220 of one row of battery cells 204 face the front side faces 216 of another row of battery cells 204.

Cooling and insulation is included in a space between adjacent rows of battery cells.

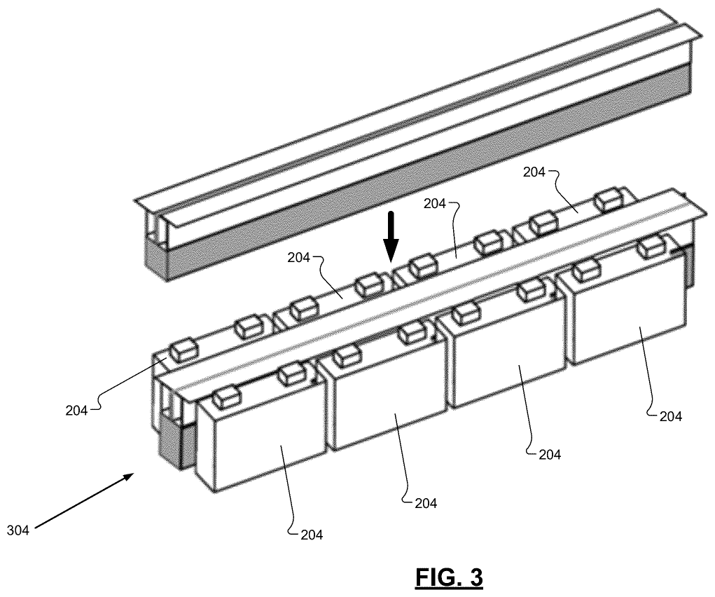

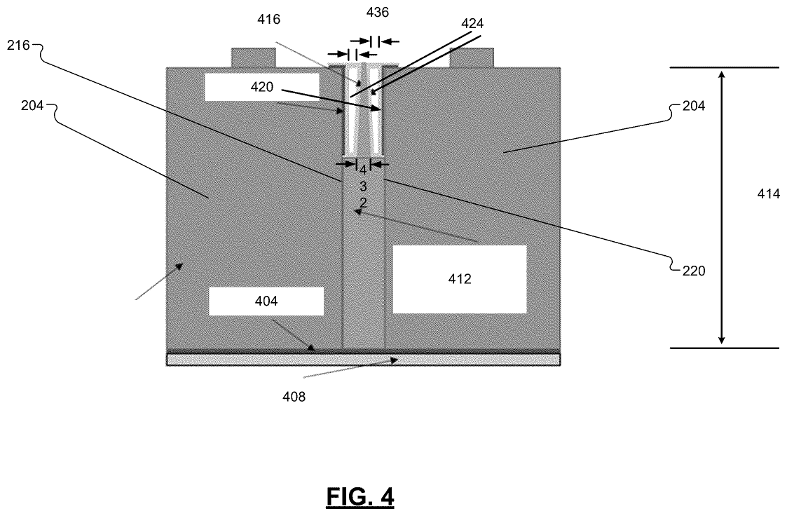

FIG. 3 includes a perspective view including the rows of battery cells of FIG. 2 with insulation material and cooling channels disposed between the rows of battery cells. FIG. 4 includes a cross sectional view from the perspective of 304 of FIG. 3.

Referring to FIGS. 3 and 4, a thermal interface material (TIM) 404 is sandwiched between the bottom faces of the battery cells 204 and a cooling plate 408. The TIM 404 is a thermally conductive material and is configured to transfer heat from the battery cells 204 to the cooling plate 408.

A thermal insulation material 412 is included and fills at least half of a vertical height 414 of the battery cells 204. The at least half may extend from the bottom surfaces vertically upward. The thermal insulation material 412 may be, for example, an aerogel. The thermal insulation material 412 is to thermally insulate adjacent battery cells of different rows.

Thermal insulation material 416, TIM 420, and cooling channels 424 are also disposed between the rows of battery cells and vertically above the thermal insulation material 412. The thermal insulation material 416, the TIM 420, and the cooling channels 424 may be disposed horizontally between top corners of adjacent battery cells of different rows.

The thermal insulation material 416 may be, for example, mica or another suitable thermally insulative material. The TIM 420 is a thermally conductive material and is configured to transfer heat from the battery cells 204 (near the top corners) to the cooling channels 424. The thermal insulation material 416 is disposed horizontally between the cooling channels 424. While the example of two cooling channels is illustrated, a single cooling channel or more than two cooling channels may be included.

As illustrated, a width 432 of the thermal insulation material 416 in a horizontal direction perpendicular to the side faces of the battery cells 204 may decrease moving vertically upward. A cross-section of the thermal insulation material 416 may be triangular or a triangular frustum.

A width 436 of the interior of the cooling channels 424 in a horizontal direction perpendicular to the side faces of the battery cells 204 may decrease moving vertically downward. A cross-section of the cooling channels 424 may be triangular or a triangular frustum. This shape may provide increased cooling at the top corners of the battery cells 204.

A cooling fluid flows through the cooling channels 424 (which may also be referred to as coolant channels) and draws heat from the battery cells 204. The cooling channels 424 may be made of a thermally conductive material, such as aluminum, copper, or another suitable thermally conductive material. Having the two cooling channels 424 shown may help more evenly transfer heat away from both rows of battery cells 204.

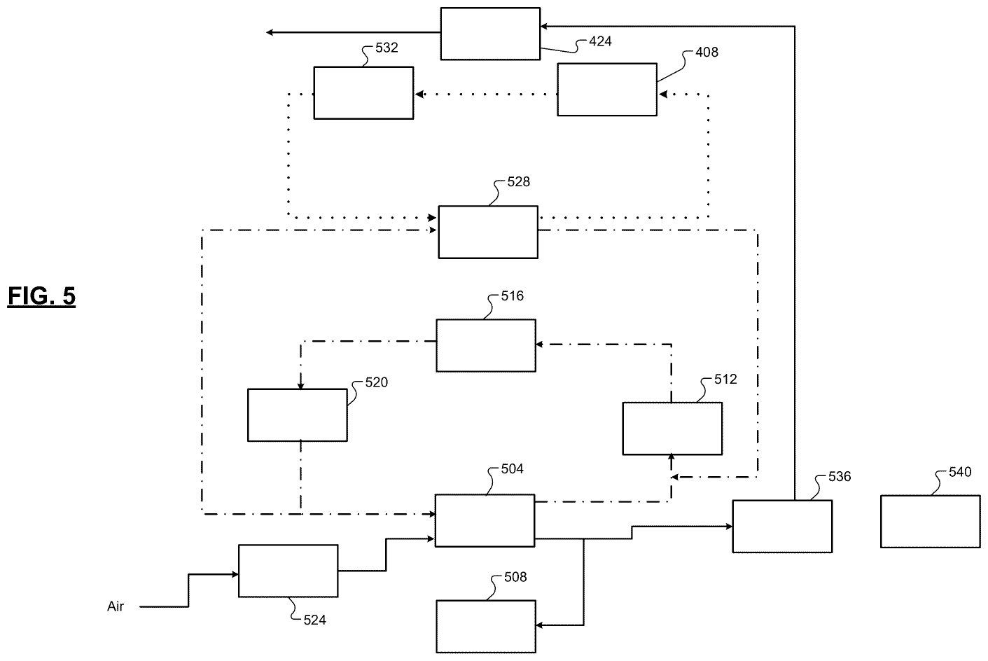

FIG. 5 is a functional block diagram of an example heating and cooling system for the battery pack 199. Air is illustrated by solid lines. Dotted lines are illustrative of a liquid coolant (e.g., water or antifreeze). Lines that include alternating dashes and dots illustrate a heating ventilation and air conditioning (HVAC) refrigerant. In the example of FIG. 5, air cooled by an evaporator 504 of an HVAC system for a passenger cabin 508 of the vehicle flows through the cooling channels 424.

In the HVAC system, a compressor 512 compresses refrigerant input to a condenser 516. Refrigerant flows from the condenser to an expansion valve 520 before flowing to the evaporator 504. The evaporator 504 cools air passing through and past the evaporator 504. A blower or fan 524 may increase airflow through and/or past the evaporator 504. The air cooled by the evaporator may flow into the passenger cabin 508 to provide cooling within the passenger cabin 508.

Refrigerant output from the expansion valve 520 may also flow to a chiller 528 before returning to the compressor 512. The chiller 528 may transfer heat from the liquid coolant to the refrigerant and cool the liquid coolant.

In the liquid coolant loop, cooled liquid coolant output from the chiller 528 flows to the cooling plate 408 to cool the battery cells 204 via the bottom surfaces of the battery cells 204. Warmer liquid coolant output from the cooling plate 408 may flow to a radiator 532, which may transfer heat away from the liquid coolant and to air passing the radiator 532.

The cooled air output from the evaporator 504 may flow to a valve 536. When the valve 536 is open, the cooled air may flow to and through the cooling channels 424 to cool the rows of battery cells 204. A valve control module 540 may control opening and closing of the valve 536. The valve control module 540 may open the valve 536 for example, when charging or discharging of the battery pack 199 is occurring, when a temperature of a battery cell is greater than a predetermined temperature, and/or when one or more other predetermined conditions are satisfied.

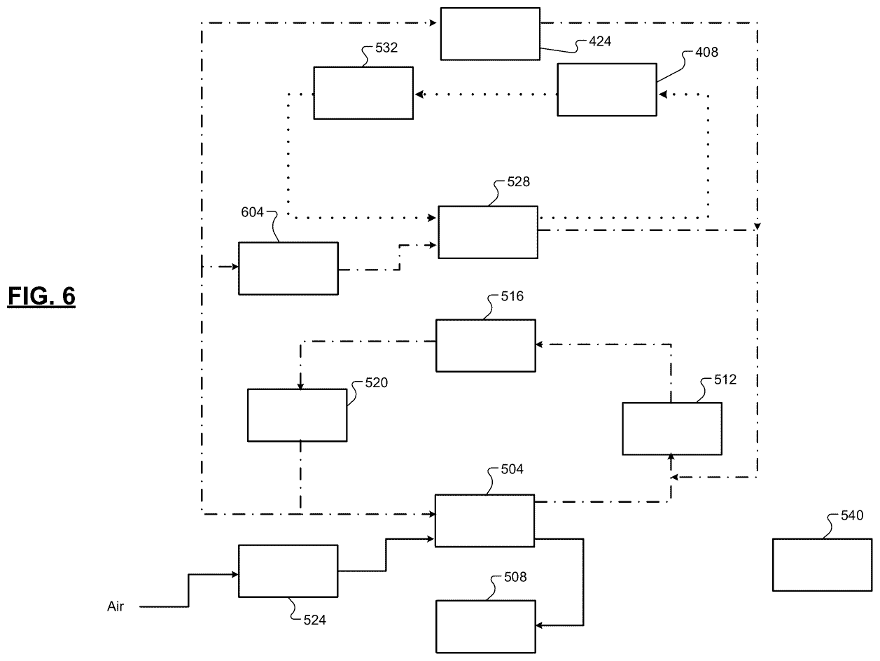

FIG. 6 is a functional block diagram of an example heating and cooling system for the battery pack 199. Air is illustrated by solid lines. Dotted lines are illustrative of a liquid coolant (e.g., water or antifreeze). Lines that include alternating dashes and dots illustrate a heating ventilation and air conditioning (HVAC) refrigerant. In the example of FIG. 6, cool refrigerant of the HVAC system flows through the cooling channels 424 to cool the rows of battery cells 120.

In this example, refrigerant output from the expansion valve 520 flows to the cooling channels 424. Refrigerant output from the cooling channels 424 may return to the compressor 512.

A valve 604 may be implemented to regulate refrigerant flow through the chiller 528. The valve control module 540 may open the valve, for example, when charging or discharging of the battery pack 199 is occurring, when a temperature of a battery cell is greater than a predetermined temperature, and/or when one or more other predetermined conditions are satisfied.

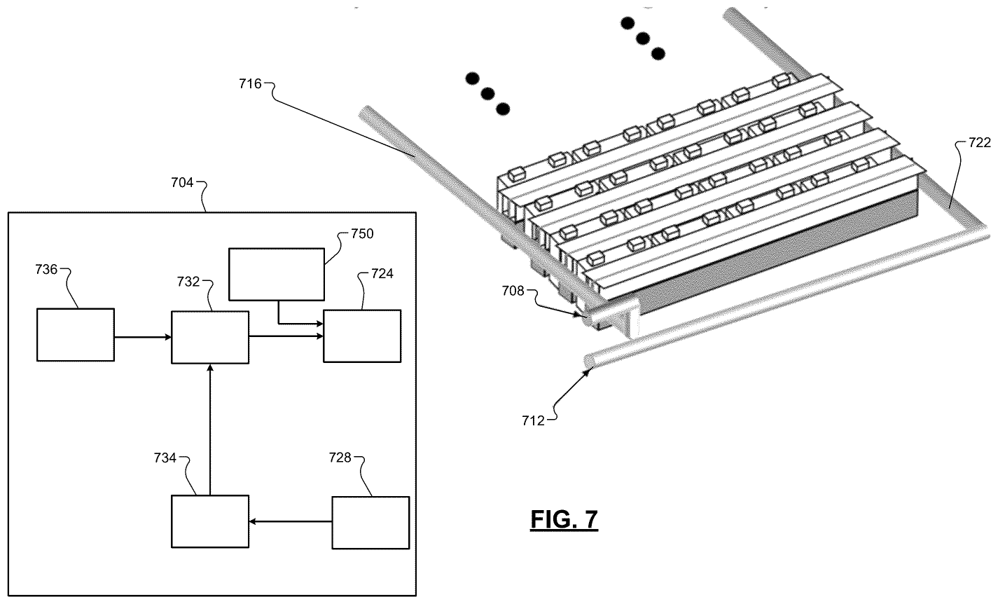

FIG. 7 is a functional block diagram and perspective view of an example cooling system involving a charging station 704. The charging station 704 may charge the battery pack 199.

In this example, the charging station 704 may also flow cooling fluid through the cooling channels 424 between the rows of battery cells 204. The vehicle may include a cooling fluid input port 708 and a cooling fluid output port 712. The cooling fluid input port 708 may be connected to an input manifold 716 to which inputs of the cooling channels 424 between each row of battery cells 204 are fluidly connected and receive cool cooling fluid from. The cooling fluid output port 712 may be connected to an output manifold 722 to which outputs of the cooling channels 424 between each row of battery cells 204 are fluidly connected and receive warmed cooling fluid from.

The charging station 704 may include an inlet connector 724 configured to fluidly connect to the cooling fluid input port 708 directly. In various implementations, a cooling conduit (e.g., hose) may be fluidly connected between the cooling fluid input port 708 and the inlet connector 724 and fluidly connect the inlet connector 724 and the cooling fluid input port 708.

The charging station 704 may include an outlet connector 728 configured to fluidly connect to the cooling fluid output port 712 directly. In various implementations, a cooling conduit (e.g., hose) may be fluidly connected between the cooling fluid output port 712 and the outlet connector 728 to fluidly connect the outlet connector 728 and the cooling fluid output port 712.

A pump 732 pumps relatively cooler cooling fluid (e.g., air, water, antifreeze, refrigerant, etc.) to the cooling channels 424 via the inlet connector 724 and the cooling fluid input port 708. The cooling fluid cools the battery cells 204 of the rows and becomes warmer. The relatively warmer cooling fluid returns to a coolant tank 734 via the outlet connector 728 and the cooling fluid output port 712.

A control module 736 may control whether the pump 732 is on or off. The control module 736 may turn on the pump 732 and cool the battery cells 204, for example, when the charging station 704 is charging the battery pack 199. In various implementations, the control module 736 may control a speed of the pump 732. For example, the control module 736 may for example increase the speed of the pump 732 as a temperature of the battery pack 199 increases and vice versa.

Additionally, a compressor 750 may be included. The control module 736 may operate the compressor 750 to evacuate the cooling fluid from the battery pack 199 when the charging of the battery pack 199 is complete. The compressor 750 may, for example, input compressed air to the input port 708.

The cooling system provided herein provides additional cooling to enable faster charging. Corner cooling reduces cell temperature gradient during charging and decreases maximum temperature experienced during charging. The cooling channels also increase mechanical strength for loadbearing which may improve packing efficiency and/or reduce battery pack cost. The inclusion of the two cooling channels may help provide thermal runaway protection (and avoid thermal runaway). The thermal insulation material between the cooling channels may also provide thermal runaway protection. The shape of the cooling channels discussed above (triangular or triangular frustum cross-section) may help accommodate uneven battery cell expansion.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Vertical may be expressed as perpendicular to a ground surface. Horizontal may a plane that is horizontal to the ground surface. Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A battery pack comprising:
prismatic battery cells arranged in two linear rows;
a cooling plate disposed vertically below the battery cells;
a thermal interface material disposed between the battery cells and the cooling plate;
a thermal insulation material disposed at vertical bottoms of a linear space between the two linear rows of battery cells;
a first cooling fluid channel that is configured to receive a cooling fluid, that extends linearly in the direction of the linear space, and that is disposed vertically above the thermal insulation material; and
a second cooling fluid channel that is configured to receive the cooling fluid, that extends linearly in the direction of the linear space and parallel to the first cooling fluid channel, and that is disposed vertically above the thermal insulation material.

2. The battery pack of claim 1 wherein the first and second cooling fluid channels have a triangular cross-section.

3. The battery pack of claim 1 wherein the first and second cooling fluid channels have a cross-sectional shape of a triangular frustum.

4. The battery pack of claim 1 further comprising a second thermal insulation material that extends linearly in the direction of the linear space, that is disposed vertically above the thermal insulation material, and that is disposed between the first and second cooling fluid channels.

5. The battery pack of claim 4 wherein the second thermal insulation material includes mica.

6. The battery pack of claim 4 wherein the second thermal insulation material has a triangular cross-section.

7. The battery pack of claim 4 wherein the second thermal insulation material has a cross-sectional shape of a triangular frustum.

8. The battery pack of claim 1 wherein the thermal insulation material includes aerogel.

9. The battery pack of claim 1 further comprising:
second thermal interface material disposed directly between (a) the first cooling fluid channel and (b) first faces of the battery cells of a first one of the two linear rows; and
third thermal interface material disposed directly between (a) the second cooling fluid channel and (b) second faces of the battery cells of a second one of the two linear rows.

10. The battery pack of claim 1 wherein the battery cells are rectangular prismatic battery cells.

11. The battery pack of claim 1 wherein the cooling fluid is air.

12. The battery pack of claim 1 wherein the cooling fluid includes one of water and a refrigerant.

13. A vehicle including the battery pack of claim 1.

14. A cooling system comprising:
the battery pack of claim 1; and
a heating, ventilation, and air conditioning (HVAC) system configured to cool air and input the cool air to the first and second cooling fluid channels.

15. The cooling system of claim 14 further comprising a chiller configured to input a coolant to the cooling plate.

16. A cooling system comprising:
the battery pack of claim 1; and
a heating, ventilation, and air conditioning (HVAC) system configured to input cool refrigerant to the first and second cooling fluid channels.

17. The cooling system of claim 16 further comprising a chiller configured to input a coolant to the cooling plate.

18. A cooling system comprising:
the battery pack of claim 1; and
a charging station configured to:
charge the battery pack; and
input the cooling fluid to the first and second cooling fluid channels.

19. The cooling system of claim 18 wherein the charging station includes:
an inlet connector configured to fluidly connect to an input port to the first and second cooling fluid channels; and
an outlet connector configured to fluidly connect to an output port from the first and second cooling fluid channels.

20. A battery pack comprising:
prismatic battery cells arranged in linear rows;
a cooling plate disposed vertically below the battery cells;
a thermal interface material disposed between the battery cells and the cooling plate;
between each pair of the rows:
a first thermal insulation material disposed at vertical bottoms of a linear space between that pair of rows of battery cells;
a first cooling fluid channel that is configured to receive a cooling fluid, that extends linearly in the direction of the linear space, and that is disposed vertically above the first thermal insulation material;
a second cooling fluid channel that is configured to receive the cooling fluid, that extends linearly in the direction of the linear space and parallel to the first cooling fluid channel, and that is disposed vertically above the first thermal insulation material; and
a second thermal insulation material that extends linearly in the direction of the linear space, that is disposed vertically above the first thermal insulation material, and that is disposed between the first and second cooling fluid channels.
